(19) United States
(12) Patent Application Publication
(10) Pub. No.: US 2016/0238317 A1
(43) Pub. Date: Aug. 18, 2016

(54) METHOD TO ENHANCE GRAIN PROCESSING AND DIGESTIBILITY

(71) Applicant: ENGINUITY WORLDWIDE, LLC, Mexico, MO (US)

(72) Inventors: Robert L. Heimann, Centralia, MO (US); Allison Talley, Mexico, MO (US)

(73) Assignee: Enginuity Worldwide, LLC, Mexico, MO (US)

(21) Appl. No.: 15/018,399

(22) Filed: Feb. 8, 2016

Related U.S. Application Data
(60) Provisional application No. 62/113,034, filed on Feb. 6, 2015.

(51) Int. Cl. F26B 15/26; F26B 3/04; F26B 5/14

(52) U.S. Cl. CPC F26B 15/26; F26B 5/14; F26B 3/04; F26B 2200/02; F26B 2200/06; F26B 2200/24

(57) ABSTRACT

A method for processing grains, crop residues, agricultural waste materials, processing waste materials, or mixtures thereof, is provided that includes using a rotary biomass dryer to process the materials and subjecting them to a steam explosion in order to form a processed material that exhibits an increase in porosity and/or absorption potential.

### CROSS-REFERENCE TO RELATED APPLICATIONS

This application claims the benefit of provisional application Ser. No. 62/113,034 filed on Feb. 6, 2015, the contents of which are incorporated herein by reference in their entirety.

### FIELD

The present disclosure relates generally to the processing of grains, crop residues, and agricultural or processing waste materials.

### BACKGROUND

The statements in this section merely provide background information related to the present disclosure and may not constitute prior art.

Cellulosic ethanol is defined as biofuel that is produced from inedible parts of a plant including, but not limited to: wood chips, corn stover, miscanthus, and fruit peels. The lignocellulosic materials are so named because of their high composition in lignocellulose. Lignocellulose is referred to as the dry matter portion of a plant that consists of a polymer of aromatic alcohols (lignin) and polymers of carbohydrates (cellulose and hemicellulose). In order to release these polysaccharides consisting of several hundred to several thousand d-glucose units, the lignin must be broken by a pretreatment phase. The breaking of lignin bonds release the sugars to be hydrolyzed by enzymes in a similar process as that of grain ethanol production. Cellulosic ethanol production has many advantages including: utilization of plant waste material and quick growing grasses, raw material used by the process does not compete with the food industry as grain ethanol, raw materials are plentiful, and the process has the potential to provide ethanol levels competitive to those of grain ethanol. The drawbacks to cellulosic ethanol include: the extra steps required to prepare the cellulosic material are not cost or time effective, pretreatments can involve costly renovations to existing ethanol production lines, and many pretreatments require additional washing steps to decrease levels of inhibitory products that would hinder hydrolysis. While the process of producing cellulosic ethanol is very similar to that of grain ethanol, cellulosic ethanol overall proves to be less time efficient, more expensive, and production is less efficient than grain ethanol methods.

Grains, crops, and biomass used in food stuff, ethanol production, animal feeds, and beer production generally rely on the ability of enzymes or bacteria to break down starches for digestibility.

### SUMMARY

A method for processing grains, crop residues, agricultural waste materials, processing waste materials, or mixtures thereof is provided that generally comprises the steps of providing a rotary mass dryer; providing at least one processable material selected as one from the grains, crop residues, agricultural waste materials, processing waste materials, or mixtures thereof; placing the at least one processable material into the rotary mass dryer; and subjecting the at least one processable material to a steam explosion in order to form a processed material. The processed material exhibits an increase in porosity and/or absorption potential as compared to a conventional material defined as being a similar processable material that is conventionally processed.

According to another aspect of the present disclosure, the processed material exhibits an increase in one or more of nutritional value, ethanol yield, weight, or digestibility as compared to conventional material.

According to another aspect of the present disclosure, the increase in porosity of the processed material can be represented by a 10% or more increase in median diameter of the pores present in the processed material as compared to the conventional material. Alternatively, the increase in median diameter of the pores present in the processed material is greater than about 20%.

According to yet another aspect of the present disclosure, a grain, crop residue, agricultural waste material, processing waste material, or mixture thereof is provided that is processed according to the process described above and further defined herein.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawing, in which:

FIG. 1 is a graph illustrating the digestibility of neutral detergent fiber (NDF) from corn stover according to three manufacturing process treatments of the present disclosure using a rotary biomass dryer.

The drawing described herein is for illustration purposes only and is not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A rotary biomass dryer can function as a hydrothermal carbonization processor or steam dryer as it uses the heat of compression in the Second Law of Thermodynamics to produce steam thereby effectively drying with interstitial bound and unbound or added water. Details associated with the rotary mass dryer are described in U.S. Pat. No. 8,667,706, which is commonly assigned with the present application, and the entire contents of which are hereby incorporated by reference it its entirety.

A process according to the teachings of the present disclosure has the flexibility to steam dry/explode biomass materials as well as produce varying levels of biochar from raw material. By processing grains, crop residues, and agricultural or production wastes via a steam explosion according to the teachings of the present disclosure, the interstices of the material being processed open up, thereby, exposing more starches to enzymatic or bacterial action. Several examples of agricultural or production wastes include without limitation, nut shells, coffee grounds, and wood waste. The increase in porosity and absorption potential caused by exploding the water within the material leads to improvements in properties or performance as measured by an increase in nutritional value, increased ethanol yield, weight gains, starch digestibility increases, and the like.

The improvement in porosity may be measured by methods or variations of the methods developed by Brunauer-Emmett-Teller (BET) who devised a theory of adsorption of gas on a solid surface in 1938. Since the original work of Brunauer-Emmet-Teller, the BET method(s) have been expanded to include not only micro-surface area but also micro-porosity and the use of non-wetting liquids, as in mercury intrusion/extrusion porisimetry. Many industries, such as those that make or use activated carbon, biochar, mesoporous silica, and/or zeolite products are dependent on this means of measuring and predicting product performance. Activated carbon and biochar can be used in the health and animal feed industries as a binder for toxins found in the gastrointestinal tract. The quality of these products is dependent upon the porosity value and the absorption potential determined by BET or mercury porisimetry methodology. The performance of the materials processed according to the teachings of the present disclosure can be predicted by measuring surface area and volume of the newly formed pores in biomass used in industry.

Processing animal feed raw materials results in gelatinized starch which increases starch digestibility and decreased protein digestion in animal models. This becomes particularly relevant in the animal feed industry as a source of ruminant indigestible protein know as RUP or bypass protein. Protein and starch digestion decreases and increases may be measured by analytical wet chemistry methods, neutral detergent fiber digestion, and starch digestion. The processes according to the present disclosure also decreases the concentration of mycotoxins as the result of contaminated grains.

### Experimental Testing

In one form of the present disclosure, a six (6) inch rotary biomass dryer was employed with corn stover that was chopped to a size of about ¼″. In one form, the following method steps were employed:

The rotary biomass dryer was brought to temperature using Amish sawdust;

Temperature was monitored using a laser thermometer pointed at the front of the dryer screw;

Feed stock was delivered to the dryer throat via a vibratory feeder with a levelling blade attached to assist with uniformity;

Samples were taken at two varying temperatures and steam was allowed to escape and product to cool before sealing the bag;

Light roasted material was roasted between 100-150° F.;

Dark roasted material was sampled when the screw temperature was 230° F.; and

Samples were tested via NDF digestibility in rumen fluid over the course of 48 hours.

Neutral detergent fiber (NDF) digestion was used to analyze the digestibility of the corn stover samples over the course of 48 hours. NDF is an analytical technique that involves the addition of a neutral detergent that dissolves pectins, lipids, proteins, and sugars leaving only the structural components of a plant in the form of lignin, hemicellulose and cellulose. Digestibility of these components is completed in rumen fluid and is a procedure similar to that of ethanol fermentation.

The light roasted corn stover and the dark roasted corn stover were heated on a compression screw of the rotary biomass dryer with a temperature of 100-150° F. and 230° F., respectively. Both of these samples were under the 315° C. (599° F.) level at which cellulose begins to degrade and the 235° C. (455° F.) level at which hemicellulose experiences large losses in mass. The temperatures at which these samples were treated fall in the window of time in which hemicellulose and lignin have only begun to decrease. During this time frame, lignin decreases at a faster rate than that of hemicellulose.

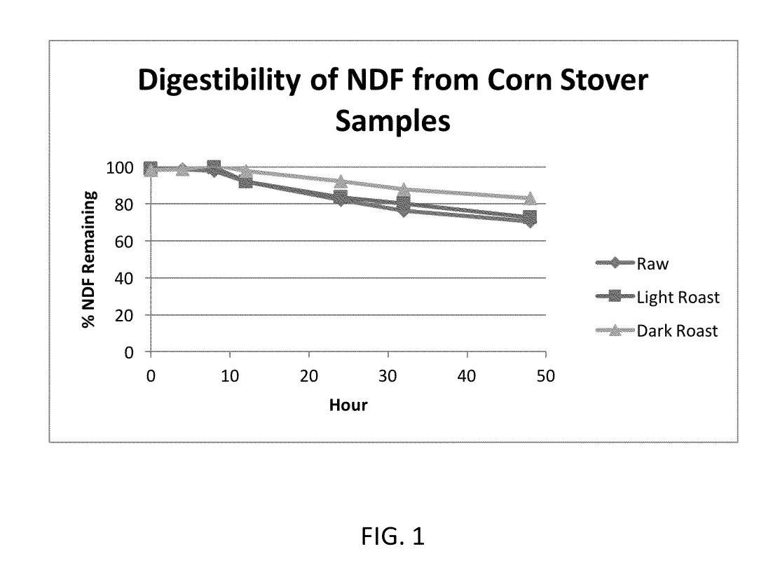

FIG. 1 shows the relationship between the digestibility of the three samples regarding NDF (%) remaining over the course of 48 hours, and Table 1 below shows data regarding the NDF (%) found in each sample before fermentation, which serves as a zero baseline as well as a comparison of fiber levels from treatment to treatment.

TABLE 1

| | NDF |
|---|---|
| Treatment | (%) |
| Raw Stover | 79.49 |
| Light Roasted Stover | 79.29 |
| Dark Roasted Stover | 68.93 |

All three samples share a similar digestion pattern up until the analysis at 12 hours. This trend is shown numerically in Table 2 below which contains the data for each digestion analysis taken during the 48 hours. (The % NDF remaining is the amount of fiber left undigested over the course of 48 hours taken sampled at the intervals listed).

TABLE 2

| | | | | 12 | 24 | 32 | 48 |
|---|---|---|---|---|---|---|---|
| | 0 Hour | 4 Hour | 8 Hour | Hour | Hour | Hour | Hour |
| Treatment | (% NDF Remaining) | | | | | | |
| Raw Stover | 98.58 | 98.80 | 97.65 | 92.05 | 82.00 | 76.30 | 70.45 |
| Light Roasted | 98.97 | 100.55 | 99.78 | 91.97 | 83.59 | 80.06 | 72.69 |
| Stover | | | | | | | |
| Dark Roasted | 98.34 | 98.70 | 100.99 | 97.85 | 92.09 | 87.89 | 82.88 |
| Stover | | | | | | | |

Analysis was completed at 0, 4, 8, 12, 24, 32, and 48 hours and expressed as NDF (%) remaining. Digestion remains very similar over the course of 48 hours for the raw and light roasted stover. The dark roasted stover sample remained similar to the raw and light roasted stover until the 12 hour mark where the gap in NDF remaining began to widen.

All three samples began with approximately 98% NDF but digested to 70.45%, 72.69%, and 82.88% for raw, light roasted, and dark roasted stover respectively. This appeared to portray a negative effect from the roaster until one analyzes the NDF levels of the samples without digestion (Table 1). The baseline NDF (%) level for raw and light roasted stover was very similar at 79.49% and 79.29% respectively. The dark roasted stover, however, was over 10% less NDF fiber (68.93%) initially than the raw and light roasted. This loss in fiber leads one to believe that the roasting technique from the rotary compression dryer caused a loss in either hemicellulose, lignin, or both. The loss of cellulose is highly unlikely since cellulose degradation does not begin until 315° C. (599° F.). When this decrease in overall initial fiber in the dark roasted is taken into account and proportions are calculated using Table 1 and 2, the levels of undigested fiber end up being very similar in all three samples as shown in Table 3:

TABLE 3

| | Amount | | |
|---|---|---|---|
| | NDF (g) | NDF | Proportion of NDF |
| | Based on 100 g | Remaining | Remaining After 48 H |
| | Sample Before | After 48 H | Based on 100 g of |
| Treatment | Digestion | Digestion (%) | Sample (g) |
| Raw Stover | 79.49 | 70.45 | 56.00 |
| Light Roasted | 79.29 | 72.69 | 57.64 |
| Stover | | | |
| Dark Roasted | 68.93 | 82.88 | 57.13 |
| Stover | | | |

Based on a 100 g sample the initial levels of fiber calculate out to 79.49 g for raw stover, 79.29 g for light roasted stover, and 68.93 g for dark roasted. After multiplying the percentages of remaining fiber at 48 hours found in Table 2 by the weight of fiber based on a 100 g sample in Table 3, the fiber weight for each sample is 56.00 g in raw stover, 57.64 g in light roasted stover, and 57.13 g in dark roasted stover.

The test data suggests from Table 1 that the technique did affect the structure of the biomass. Table 1 conveys an over 10% loss in fiber from the raw stover compared to the dark roasted stover, which is believed to be the result of a loss of hemicellulose and/or lignin due to a breaking of lignin bonds. Accordingly, the present disclosure includes a mechanism of using the rotary compression dryer and steam explosion to treat biomass. We have discovered that the destruction of the lignin releases sugars and hemicellulose onto the surface of the biomass which would improve ethanol production.

The average moisture content for each sample is listed in Table 4 below:

TABLE 4

| | Average |
|---|---|
| | Moisture |
| Treatment | Content (% wt) |
| Raw Stover | 11.58 |
| Light Roasted | 9.78 |
| Stover | |
| Dark Roasted | 6.45 |
| Stover | |

The rotary compression dryer resulted in an almost 2% moisture decrease for light roasted stover and over 3% moisture decrease for the dark roasted stover. The data from Tables 1 and 2 are evidence that the roasting process at 100-150° F. in the light roast was not enough to alter fiber content or digestibility of fiber. This data combined with the moisture data supports our discover that biomass can be heated to a dry, storable state without negatively affecting the digestion. This is beneficial for long-term storage by ethanol facilities to be able to store raw materials that are microbe free and less susceptible to invading microbial growth due to the dry state.

The NDF digestion data clearly shows that the structure of the biomass is altered by the rotary biomass dryer. Steam explosion appears to be the result of an increase in heat and pressure due to the relationship between the compression screw and the biomass material. Structural changes from temperatures at which this experiment took place would include the loss of hemicellulose and lignin which have the potential to improve sugar digestion in ethanol production.

As further shown by the test data herein, biomass can be heated and dried to a low moisture state without an alteration of digestion.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for processing grains, crop residues, agricultural waste materials, processing waste materials, or mixtures thereof, the method comprising:
providing a rotary mass dryer;
providing at least one processable material, the at least one processable material being selected from the group consisting of grains, crop residues, agricultural waste materials, processing waste materials, and mixtures thereof;
placing the at least one processable material into the rotary mass dryer; and
subjecting the at least one processable material to a steam explosion in order to form a processed material,
wherein the processed material exhibits an increase in porosity and/or absorption potential.

2. The method according to claim 1, wherein the processed material exhibits an increase in one or more of nutritional value, ethanol yield, weight, or digestibility.

3. The method according to claim 1, wherein the agricultural or processing waste material includes at least one selected from the group consisting of nut shells, coffee grounds, and wood waste.

4. The method according to claim 1, wherein the increase in porosity of the processed material comprises at least a 10% increase a median diameter of pores present in the processed material.

5. The method according to claim 4, wherein the increase in median diameter of the pores in the processed material is greater than about 20%.
